(19) United States
(12) Patent Application Publication
(10) Pub. No.: US 2024/0417577 A1
(43) Pub. Date: Dec. 19, 2024

(54) COMPOSITION AND COATING MATERIAL

(71) Applicant: Toray Industries, Inc., Tokyo (JP)

(72) Inventors: Tomohiro Kato, Otsu-shi, Shiga (JP); Eiichiro Tamaki, Otsu-shi, Shiga (JP)

(73) Assignee: Toray Industries, Inc., Tokyo (JP)

(21) Appl. No.: 18/703,747

(22) PCT Filed: Oct. 25, 2022
(86) PCT No.: PCT/JP2022/039610

§ 371 Date: Apr. 23, 2024

(30) Foreign Application Priority Data
Nov. 1, 2021 (JP) 2021-178486

(51) Int. Cl. C09D 7/62; B82Y 30/00; C08K 3/08; C08K 9/04

(52) U.S. Cl. CPC C09D 7/62; B82Y 30/00; C08K 2003/0893; C08K 9/04; C08K 2201/011

(57) ABSTRACT

To provide a composition having excellent corrosion resistance and durability. Provided is a composition containing a curable resin and/or a precursor thereof, inorganic particles, and graphene, wherein the graphene has an average thickness of 0.30 nm to 50 nm.

### CROSS REFERENCE TO RELATED APPLICATIONS

This application is a US national stage filing under 35 U.S.C. § 371 of International Application No. PCT/JP2022/039610, filed Oct. 25, 2022, which claims priority to Japanese Patent Application No. 2021-178486, filed Nov. 1, 2021, each of which is incorporated herein by reference in its entirety.

### TECHNICAL FIELD

This disclosure relates to a composition and a protective coating material using the composition.

### BACKGROUND

In recent years, application development of graphene has been actively studied, and particularly, a coating film technique utilizing a thin layer sheet structure of graphene has attracted attention. The thin layer sheet structure of graphene can inhibit transmission of oxygen and water, which are corrosion-causing substances. Examples of an application utilizing such a function of graphene include a corrosion-resistant coating material, and further improvement in corrosion resistance is expected due to the use of graphene.

On the other hand, steel materials used for structures such as buildings, steel towers, and bridges are required to be improved in resistance to rust, and coating materials having a high anti-rust function typified by heavy-duty anti-corrosive coating materials are used. As a heavy-duty anti-corrosive coating material, a zinc-rich paint containing zinc and the like have been proposed. As a technique for saving the consumption of metal zinc resource in an anti-corrosive coating material containing zinc, for example, a zinc carbon alkene anti-corrosive primer containing an epoxy resin, a solvent, a dispersion medium, a zinc powder, an anti-settling agent, and a carbon alkene has been proposed (see, for example, CN 105623473 A).

In addition, as a composition suitable for anti-corrosive coating using nanoplatelets or for metal coating, there have been some proposals, for example, a coating composition including inorganic nanoplatelets and an oligomer, the inorganic nanoplatelets being modified by the oligomer and forming mesomorphic structure in a resin matrix (see, for example, JP 2017-512845 A), and a composition including graphene platelets and a carrier medium, the graphene platelets including one of or a mixture of two or more of graphene nanoplates, bilayer graphene nanoplates, few-layer graphene nanoplates, and/or graphite flakes in which the graphite flakes have one nanoscale dimension and 25 or less layers (see, for example, JP 2021-512995 A).

However, the compositions described in CN 105623473 A, JP 2017-512845 A and Patent Document 3: JP 2021-512995 A all have the problem that corrosion resistance is still insufficient. In addition, corrosion resistance tends to decrease in long-term use, and there is also a problem in durability.

It could therefore be helpful to provide a composition from which a cured product superior in corrosion resistance and durability can be obtained.

### SUMMARY

Our composition is a composition mainly including a curable resin and/or a precursor thereof, inorganic particles, and graphene, wherein the graphene has an average thickness of 0.30 nm or more and 100 nm or less.

By curing the composition, a cured product superior in corrosion resistance and durability can be obtained. The composition can provide a coating material a cured product of which is superior in corrosion resistance and durability, a coating film thereof, and a structure coated therewith.

### DETAILED DESCRIPTION

The composition includes a curable resin and/or a precursor thereof, inorganic particles, and graphene having an average thickness of 0.30 nm or more and 100 nm or less. The curable resin and the precursor thereof have a function as a binder that holds the inorganic particles and the graphene in the composition. The inorganic particles have a function of inhibiting transmission of water and oxygen, which are corrosion-causing substances. As described above, since graphene has a thin layer sheet structure, it is possible to inhibit transmission of water and oxygen, which are corrosion-causing substances (shielding effect). Furthermore, since graphene has conductivity, when graphene is combined with inorganic particles, the graphene electrically connect the inorganic particles to form a conductive network, and exhibits a sacrificial anti-corrosion effect in which the inorganic particles rust before a steel material. To obtain these effects more efficiently, it is important that graphene maintains a thin layer state in a composition and is highly dispersed, and since such graphene can assist and enhance an inorganic particle function, high corrosion resistance performance can be obtained even with a smaller content of inorganic particles.

The average thickness of graphene is an index of the maintainability and dispersibility of the graphene in a thin layer state in a composition. If a thin layer state cannot be maintained, the graphene loses its sheet form, is rounded, and becomes thick. In addition, when graphene is poor in dispersibility, the graphene forms agglomerates via inter-sheet agglomeration or in-plane agglomeration, and becomes thick. That is, the smaller the average thickness of graphene is, the more highly the graphene is dispersed while maintaining its thin layer state in a composition, and the more superior in the shielding effect and the conductive network forming ability the graphene is.

The average thickness of the graphene in the composition is 0.30 nm or more and 100 nm or less. The average thickness of graphene of 0.30 nm is the theoretical minimum value of the thickness of graphene, and indicates that the graphene is single-layer graphene. On the other hand, when the average thickness of the graphene is 100 nm or less, the high dispersibility in the composition, the shielding effect due to the thin layer sheet structure, and the sacrificial anti-corrosion effect due to the formation of a conductive network can be enhanced, and the corrosion resistance and durability of a cured product can be further improved. The average thickness of the graphene is preferably 50 nm or less, more preferably 20 nm or less, still more preferably 10 nm or less, and further preferably 6 nm or less.

Herein, the average thickness of the graphene is calculated by collecting the graphene from the composition, observing the graphene with an atomic force microscope in an enlarged manner in a square field of view of about 1 to 20 μm on each side such that the graphene can be appropriately observed, measuring the thickness of each of 10 pieces of graphene randomly selected, and determining the arithmetic average value thereof. The thickness of each piece of graphene is an arithmetic average value of values of thickness measured at five points randomly selected for each piece of graphene.

After a cured product such as a coating film is formed, a cured product piece obtained by peeling and cutting the coating film with a spatula is subjected to section exposure by ion milling, and TEM analysis of the section is performed through observation in an enlarged manner in a square field of view of about 10 to 100 nm on each side such that the graphene can be appropriately observed. The thickness of each of 10 pieces of graphene randomly selected is measured, the arithmetic average value thereof is then determined, and thereby the average thickness is calculated. The thickness of each piece of graphene is an arithmetic average value of values of thickness measured at five points randomly selected for each piece of graphene.

Curable Resin and/or Precursor Thereof

The curable resin refers to a resin that cures through volatilization of a solvent or a reaction, and examples thereof include an epoxy resin, a urethane resin, an acrylic resin, a polyester resin, a melamine resin, a silicone resin, an alkyd resin, and a silicate resin, and a commercially available curable resin for a coating composition use can be suitably used. Two or more of them may be contained. Among them, an epoxy resin, a urethane resin, an acrylic resin, and a silicate resin are preferable from the viewpoint of coatability and handleability. In addition, from the viewpoint of forming a bond with the graphene and, having a surface treatment agent on the graphene, a bond with the surface treatment agent, enhancing coating film strength, and further enhancing durability, a crosslinking reactable resin is preferable, and an epoxy resin, a urethane resin, or a silicate resin is more preferable, and an epoxy resin or a silicate resin is still more preferable.

Examples of the epoxy resin include a bisphenol A type epoxy resin, a bisphenol F type epoxy resin, and a novolac type epoxy resin, and examples of modified products thereof include an acryl-modified epoxy resin and a urethane-modified epoxy resin. Two or more of them may be contained. Among them, a bisphenol A type epoxy resin, a bisphenol F type epoxy resin, and a novolac type epoxy resin are preferable.

The epoxy equivalent of the epoxy resin is preferably 100 or more and 5,000 or less. When the epoxy equivalent is 100 or more, the strength of a coating film obtained from the composition can be enhanced. On the other hand, when the epoxy equivalent is 5,000 or less, the composition can be efficiently cured.

When the composition contains an epoxy resin as the curable resin, the composition preferably further contains a curing agent for epoxy resins. That is, the composition may contain an epoxy resin and a curing agent for epoxy resins, or the composition may contain an epoxy resin as the curable resin and may be used in combination with a curing agent for epoxy resins prepared separately. The composition may contain a curing agent for epoxy resins in place of the curable resin, and may be used in combination with an epoxy resin prepared separately. Examples of the curing agent for epoxy resins include a polyfunctional amine compound and a polyamide amine compound, and a commercially available curing agent for epoxy resins can be used. Two or more of them may be contained. The active hydrogen equivalent of the curing agent for epoxy resins is preferably 30 or more and 5,000 or less. When the active hydrogen equivalent is 30 or more, the strength of a coating film obtained from the composition can be enhanced. On the other hand, when the active hydrogen equivalent is 5,000 or less, the composition can be efficiently cured.

Examples of the polyfunctional amine compound include aliphatic polyamines, aromatic polyamines, and alicyclic polyamines. Examples of the aliphatic polyamines include alkylenediamines having 2 to 10 carbon atoms such as ethylenediamine, propylenediamine, and hexamethylenediamine, and polyalkylene polyamines having 4 to 20 carbon atoms such as diethylenetriamine and triethylenetetramine. Examples of the aromatic polyamines include aromatic polyamines having 6 to 20 carbon atoms such as phenylenediamine and diphenyl ether diamine. Examples of the alicyclic polyamines include N-aminoethylpiperazine, isophoronediamine, methylenebiscyclohexanamine, norbornene diamine, and 1,2-diaminocyclohexane.

Examples of the polyamide amine compound include “LUCKAMIDE” (registered trademark) TD-960, TD-961, TD-977, and TD-984 manufactured by DIC Corporation, and NEWMIDE (trade names) 500, 515, and 522 manufactured by Harima Chemicals Group, Inc.

As the urethane resin, an ester-based urethane resin, an ether-based urethane resin, and a carbonate-based urethane resin are preferable, and an ester-based urethane resin and a carbonate-based urethane resin are more preferable.

Examples of a precursor of the urethane resin include a polyol and a curing agent for urethane resins. It is possible that the composition is made to contain only a polyol or a curing agent for urethane resins as a curable resin precursor and then used in combination with a curing agent for urethane resins or a polyol separately prepared. Our composition shall include only one of a polyol and a curing agent for urethane resins is contained as the curable resin and/or a precursor thereof.

Examples of the polyol include a polyester-based polyol, a polyether-based polyol, and a polycarbonate-based polyol. Examples of the polyester-based polyol include condensates of polyols such as alkylene glycols and alkylene diols with carboxylic acids such as glutaric acid and adipic acid. Examples of the polyether-based polyol include polyoxyethylene diol, polyoxyethylene triol, polyoxypropylene diol, and polyoxypropylene triol. Examples of the polycarbonate-based polyol include compounds obtained via a dealcoholization or a dephenolization reaction of a polyol such as an alkylene glycol or an alkylene diol with a dialkyl carbonate, a diaryl carbonate or the like.

Examples of the curing agent for urethane resins include polyisocyanate. Examples of the polyisocyanate include aromatic polyisocyanates, aliphatic polyisocyanates, alicyclic polyisocyanates, and modified products thereof. Examples of the aromatic polyisocyanates include tolylene diisocyanate, 4,4′-diphenylmethane diisocyanate, xylylene diisocyanate, and paraphenylene diisocyanate. Examples of the aliphatic polyisocyanates include hexamethylene diisocyanate and lysine diisocyanate. Examples of the alicyclic polyisocyanates include isophorone diisocyanate and 4,4′-dicyclohexylmethane diisocyanate.

The acrylic resin preferably contains, for example, acrylic acid, methacrylic acid or a derivative thereof as a copolymerization component. Examples of the derivatives of acrylic acid and methacrylic acid include esterified products of acrylic acid or methacrylic acid, acrylamide, methacrylamide, and fluorinated alkyl acrylates. The acrylic resin may further contain a non-acrylic component such as styrene, an acrylate-functionalized polydimethylsiloxane or the like as the copolymerization component.

The silicate resin is preferably, for example, amorphous silica and/or an alkoxysilane compound, and examples thereof include tetraethoxysilane, tetramethoxysilane, tetraisopropoxysilane, and derivatives thereof.

### Inorganic Particles

Examples of the inorganic particles include anti-rust pigments and extender pigments which are commonly used for coating materials. When the composition is used as a protective coating material, the corrosion resistance of a cured product can be further improved by selecting a material having a high sacrificial anti-corrosion effect depending on the relationship with the object to be protected. For example, use as a protective coating material for protecting steel, the corrosion resistance and durability of a cured product can be further improved by a sacrificial anti-corrosion effect as a result of selection of zinc particles as an inorganic material.

The inorganic particles preferably include zinc, iron oxide, mica, talc, bentonite, silicon dioxide, titanium oxide, aluminum oxide, barium sulfate, stainless steel, glass, or aluminum. Two or more of them may be contained.

Examples of the shape of the inorganic particles include a spherical shape, a flaky shape, a scaly shape, a fiber-like shape, and an irregular shape.

Among them, mica, talc, bentonite, scaly titanium oxide, stainless steel flakes, glass flakes, and aluminum flakes have a high shielding effect due to their flat shape, and can further improve the corrosion resistance of a cured product. Zinc particles have a high sacrificial anti-corrosion effect, and can further improve the corrosion resistance of a cured product. It is preferable to combine talc, bentonite, glass flakes or the like together with zinc particles, and the viscosity of the composition and the mechanical properties of a coating film obtained from the composition can be easily adjusted to desired ranges.

The average particle size (Ra) of the inorganic particles is preferably 20 μm or less, more preferably 15 μm or less, and still more preferably 10 μm or less from the viewpoint of inhibiting defects such as pinholes and further improving the corrosion resistance of a cured product. On the other hand, from the viewpoint of enhancing the shielding effect and sacrificial anti-corrosion effect by the inorganic particles and further improving the corrosion resistance and durability of a cured product, the average particle size is preferably 0.5 μm or more, more preferably 1.0 μm or more, and still more preferably 2.0 μm or more. The average particle size of the inorganic particles can be easily adjusted to the above range using a known particle pulverization technique. In addition, commercially available inorganic particles having a desired particle size can be purchased and used.

The content of the inorganic particles in the composition is preferably 5% by weight or more and 60% by weight or less based on the total solid weight of the composition. When the inorganic particles are contained in an amount of 5% by weight or more, the corrosion resistance and durability of a cured product can be further improved. The content of the inorganic particles is more preferably 10% by weight or more, and still more preferably 20% by weight or more. On the other hand, from the viewpoint of inhibiting defects such as pinholes or cracks and further improving the corrosion resistance and durability of a cured product, the content of the inorganic particles is preferably 60% by weight or less, more preferably 50% by weight or less, and still more preferably 40% by weight or less.

Zinc rich coating materials and the like containing a large amount of zinc are commonly used to enhance corrosion resistance, but since corrosion resistance and durability are improved by the addition of graphene, high corrosion resistance and durability can be obtained even with a smaller amount of zinc, and the amount of zinc can be reduced.

When the raw material proportion of the composition is known, the content of the inorganic particles in the composition can be calculated from the raw material proportion.

When the raw material proportion is not known, the content of the inorganic particles can be determined by the following procedure. First, 100 g of the composition before curing is diluted using 100 g of the solvent of the composition, and centrifugation was performed at a rotation speed of 11, 00 rpm for 20 minutes using a centrifuge, and the supernatant is removed. After adding 100 g of the solvent again and redispersing the mixture, the operation including centrifugation at a rotation speed of 11, 00 rpm for 20 minutes using a centrifuge and removal of the supernatant is repeated twice, and thereby graphene and resin are removed. The resulting solid is separated by filtration, washed five times with a solvent, then vacuum-dried, and weighed to determine the inorganic particle weight (W1). Next, 100 g of the composition before curing is cured and then weighed, and the total solid weight (W2) is determined. The content (% by weight) of the inorganic particles in the composition can be determined from W1/W2× 100.

### Graphene

Generally, graphene refers to a sheet of sp²-bonded carbon atoms having a thickness of one atom (monolayer graphene) in a narrow sense, but a sheet having a scaly form in which monolayer graphene is laminated is also referred to as graphene. Similarly, graphene oxide referred to herein also shall include those having a laminated scaly form.

A material having an O/C ratio, which is an element ratio of oxygen atoms to carbon atoms measured by X-ray photoelectron spectroscopy (XPS), of more than 0.4 is called graphene oxide, and a material having an O/C ratio of 0.4 or less is called graphene. In addition, reduced graphene oxide, which is obtained by reducing graphene oxide, having an O/C ratio of 0.4 or less is called graphene.

Furthermore, as the graphene, one subjected to a surface treatment described later can be used, and graphene or graphene oxide subjected to the surface treatment is also referred to as “graphene” or “graphene oxide”.

The graphene may be one manufactured by a physical exfoliation method or may be one manufactured by a chemical exfoliation method. In the production by a chemical exfoliation method, the method of preparing graphene oxide is not particularly limited, and a known method such as the Hummers method can be used. Commercially available graphene oxide may be purchased.

The size in a direction parallel to a graphene layer (Rb) of the graphene is preferably 0.10 μm or more, more preferably 0.50 μm or more, and still more preferably 1.0 μm or more from the viewpoint of enhancing the shielding effect caused by a thin layer sheet structure due to high dispersibility in the composition and the sacrificial anti-corrosion effect caused by the formation of a conductive network due to the high dispersibility and thereby further improving the corrosion resistance and durability of a cured product, and from the viewpoint of easily adjusting Ra/Rb to a preferable range described later. On the other hand, from the viewpoint of inhibiting unintended agglomeration, enhancing the sacrificial anti-corrosion effect by the formation of a conductive network, and further improving the corrosion resistance and durability of a cured product, and from the viewpoint of easily adjusting Ra/Rb to a preferable range described later, the size is preferably 100 μm or less, more preferably 50 μm or less, and still more preferably 20 μm or less. The size of the graphene in the direction parallel to a graphene layer can be easily adjusted to the above-described range by refining graphene oxide or graphene after reduction by the method described later. Commercially available graphene oxide or graphene having a desired size may be used.

To achieve the shielding property and the formation of a conductive network by the addition of the graphene, it is preferable that thin layer/highly dispersible graphene as described above is used and the inorganic particles and the graphene are appropriately arranged and are in contact with each other. In particular, when the content of the inorganic particles is small, the distance between the inorganic particles increases, and thus it is preferable that the graphene is appropriately dispersed and arranged. Hence, it has been found that there is a preferable range of the ratio (Ra/Rb) of the average particle size (Ra) of the inorganic particles to the size in the direction parallel to a graphene layer (Rb). Ra/Rb is a characteristic that affects the shielding effect and the conductive network described above.

From the viewpoint of improving the property of graphene to connect between inorganic particles and further enhancing the corrosion resistance, Ra/Rb is preferably 0.5 or more, more preferably 0.6 or more, and still more preferably 0.7 or more. Similarly, Ra/Rb is preferably 6 or less, more preferably 4 or less, and still more preferably 3 or less.

The average particle size (Ra) of the inorganic particles can be measured by the method described in Measurement Example 4 of EXAMPLES described later. The size in the direction parallel to a graphene layer (Rb) of graphene can be measured by the method described in Measurement Example 2 of EXAMPLES described later.

Ra/Rb can be easily adjusted to the above-described range, for example, by using graphene and inorganic particles having Ra and Rb each falling within the preferable ranges described later.

The element ratio of oxygen to carbon (O/C ratio) of graphene measured by X-ray photoelectron spectroscopy represents the amount of functional groups possessed by the graphene, and serves as an index of affinity with a solvent or a curable resin and/or a precursor thereof. Functional groups of the graphene enhance affinity with the solvent or the curable resin and/or a precursor thereof, and facilitate dispersion of the graphene while maintaining a thin layer sheet structure, and can further improve the corrosion resistance of a cured product. In addition, the durability can be further improved by bonds of the curable resin and/or a precursor thereof to the graphene. Therefore, the O/C ratio of the graphene is preferably 0.05 or more, and more preferably 0.08 or more. On the other hand, from the viewpoint of further inhibiting the transmission of water and oxygen and further improving the corrosion resistance and durability of a cured product, the O/C ratio is preferably 0.40 or less, and more preferably 0.30 or less.

The O/C ratio of the graphene can be measured by taking the graphene from the composition and analyzing the graphene by X-ray photoelectron spectroscopy (XPS). A C1s main peak originating from carbon atoms was assigned to 284.3 eV, an O1s peak originating from oxygen atoms was assigned to the peak around 533 eV, and an O/C ratio was calculated from the area ratio of these peaks, and the resulting value is rounded off the third decimal to the second decimal place.

Incidentally, the O/C ratio of the graphene can be easily adjusted to the above-described range by adjusting the degree of oxidation of graphene oxide as a raw material or the degree of reduction by reduction reaction conditions, for example, in using a chemical exfoliation method. Commercially available graphene oxide or graphene having a desired O/C ratio may be used. Furthermore, the O/C ratio of graphene can be easily adjusted to the above-described range by adjusting the amount of attachment of the surface treatment agent described later.

When the surface treatment agent described later contains a nitrogen atom, the atomic ratio of nitrogen to carbon (N/C ratio) of graphene measured by X-ray photoelectron spectroscopy is an index of the amount of attachment of the surface treatment agent. Attachment of the surface treatment agent containing a nitrogen atom to graphene has an action of not only enhancing the dispersibility in the resin, but also relaxing the stress generated in the resin located particularly between inorganic particles, and inhibiting the occurrence of cracks during drying or curing of the composition. By inhibiting the occurrence of cracks, the corrosion resistance and durability of a cured product can be further improved. Therefore, the N/C ratio of the graphene is preferably 0.005 or more, more preferably 0.007 or more, and still more preferably 0.010 or more. On the other hand, the N/C ratio of the graphene is preferably 0.200 or less, more preferably 0.100 or less, and still more preferably 0.050 or less from the viewpoint of inhibiting unintended agglomeration and further improving the corrosion resistance and durability of a cured product.

The N/C ratio of the graphene can be measured by collecting the graphene from the composition and analyzing the graphene by XPS. A C1s main peak originating from carbon atoms was assigned to 284.3 eV, an N1s peak originating from nitrogen atoms was assigned to the peak around 402 eV, and an N/C ratio was calculated from the area ratio of these peaks, and the resulting value is rounded off the fourth decimal to the third decimal place.

The N/C ratio of the graphene can be easily adjusted to the above-described range by, for example, the amount of attachment of the surface treatment agent described later.

When surface-treated graphene is used as the graphene, the surface treatment agent preferably has a nitrogen atom. The nitrogen atom gives a positive charge to the surface treatment agent, and the positive charge can be electrostatically adsorbed to the negative charge of the graphene. The electrostatic adsorption is dynamic unlike a rigid covalent bond, an effect of relaxing stress is obtained, and the durability of a coating film is further improved. The nitrogen atom is preferably derived from a compound having an amino group, and the crosslinking reactive resin and the amino group react to form crosslinking so that the durability of a coating film can be further enhanced.

The nitrogen atom is preferably derived from a primary amine, a secondary amine, a tertiary amine, a quaternary ammonium salt, or a nitrogen-containing cyclic compound. The nitrogen atom may have two or more nitrogen atoms derived from a plurality of different compounds, or one compound may have two or more nitrogen atoms.

The surface treatment agent may be either a low molecular weight compound or a high molecular weight compound. From the viewpoint of further improving corrosion resistance, a low molecular weight compound is preferable, and from the viewpoint of further improving durability, a high molecular weight compound is preferable. The low molecular weight compound refers to a compound having a molecular weight of less than 1,000, and the high molecular weight compound refers to a compound having a molecular weight of 1,000 or more.

When the surface treatment agent has a low molecular weight compound, the surface treatment agent preferably has an aromatic ring and/or an alkyl group to make it easy to attach the surface treatment agent to the graphene. In the present description, the aromatic ring refers to a cyclic structure that satisfies the Hückel's rule and has aromaticity.

Examples of the surface treatment agent having an aromatic ring include 2-halogenated aniline, 3-halogenated aniline, 4-halogenated aniline, benzylamine, phenylethylamine, 1-naphthylamine, 2-naphthylamine, aniline, p-toluidine, m-toluidine, o-toluidine, 1-aminoanthracene, 2-aminoanthracene, 9-aminoanthracene, 1-aminopyrene, N-methylaniline, N-ethylaniline, N-iropropylaniline, 4-ethylaniline, 4-isopropylaniline, N,N-dimethylaniline, 4-nitroaniline, diphenylamine, N-methyldiphenylamine, 2,4,6-trimethylaniline, 4-methoxyaniline, N-methylbenzylamine, N,N-dimethylbenzylamine, N,N-diethylbenzylamine, benzamide, dopamine, phenylalanine, tyrosine, tryptophan, histidine, and salts thereof. Two or more of them may be used.

Examples of the surface treatment agent having an alkyl group include monoamine compounds such as n-butylamine, n-hexylamine, n-octylamine, n-dodecylamine, n-octadecylamine, sec-butylamine, tert-butylamine, isobutylamine, 3-aminopentane, 3-methylbutylamine, 2-heptylamine (2-aminoheptane), 2-aminooctane, 2-ethylhexylamine, and 1,2-dimethyl-n-propylamine, alkylenediamines having 2 to 10 carbon atoms such as ethylenediamine, propylenediamine, and hexamethylenediamine, aromatic polyamines having 6 to 20 carbon atoms such as 1,6-diaminopyrene, 1,8-diaminopyrene, 1,4-phenylenediamine, 1,3-phenylenediamine, 1,2-phenylenediamine, 1,4-diaminoanthraquinone, 1,5-diaminonaphthalene, 1,8-diaminonaphthalene, 2,3-diaminonaphthalene, p-xylenediamine, m-xylenediamine, and 1,2,4-triaminobenzene, and polyalkylene polyamines having 4 to 20 carbon atoms such as diethylenetriamine and triethylenetetramine. Two or more of them may be used.

When the surface treatment agent is a high molecular weight compound, the weight average molecular weight thereof is preferably 5,000 or more, and more preferably 10,000 or more from the viewpoint of easily attaching the surface treatment agent to graphene and further improving durability. On the other hand, the weight average molecular weight of the surface treatment agent is preferably 500,000 or less, more preferably 200,000 or less, and still more preferably 100,000 or less from the viewpoint of inhibiting agglomeration. Examples of the high molecular weight surface treatment agent having a weight average molecular weight within such a range include “EPOMIN” (registered trademark) and “POLYMENT” (registered trademark) manufactured by Nippon Shokubai Co., Ltd.

In addition, a curing agent for epoxy resins may be used as the surface treatment agent, and the above-described curing agent for epoxy resins can be preferably used. For example, various products such as “LUCKAMIDE” (registered trademark) manufactured by DIC Corporation, “jER CURE” (registered trademark) manufactured by Mitsubishi Chemical Corporation, and NEWMIDE (trade name) manufactured by Harima Chemicals Group, Inc. are commercially available. Use of these curing agents as surface treatment agents is preferable because of their high affinity with a thermally curable resin and/or a precursor thereof.

The chemical structure of the surface treatment agent can be specified by TOF-SIMS.

The content of the graphene in the composition is preferably 0.01% by weight or more and 0.9% by weight or less based on the total solid weight. Since the graphene in the composition maintains a thin layer and is superior in dispersibility, the effect can be exhibited by adding the graphene in a small amount. When graphene having poor dispersibility and not being in a thin layer any longer is used, the required amount of the graphene tends to increase. In addition, a composition containing agglomerated graphene is prone to cause defects such as pinholes. Therefore, it is favorable that a high effect is obtained by adding graphene in an amount reduced as much as possible.

When the content of the graphene is set to 0.01% by weight or more, corrosion resistance and durability can be further improved due to the shielding effect of the graphene and the formation of a conductive network. The content of the graphene is more preferably 0.05% by weight or more, and still more preferably 0.08% by weight or more based on the total solid weight. On the other hand, when the content of the graphene is set to 0.9% by weight or less, unintended agglomeration can be inhibited, and corrosion resistance and durability can be further improved. The content of the graphene is more preferably 0.6% by weight or less, and still more preferably 0.4% by weight or less based on the total solid weight.

### Others

The composition may further contain a solvent or an optional additive.

As the solvent, a solvent capable of dissolving the above-described curable resin and/or the precursor thereof and capable of being volatilized is preferable, and the solvent can be appropriately selected according to the coatability of the composition. Examples thereof specifically include mineral oil, xylene, toluene, ethylbenzene, MIBK (methyl isobutyl ketone), MEK (methyl ethyl ketone), acetone, butyl acetate, ethyl acetate, n-butanol, isobutanol, isopropyl alcohol, ethanol, N-methylpyrrolidone, and N,N-dimethylformamide. Two or more of them may be contained.

When an aromatic solvent such as xylene or toluene is used, the content of the aromatic solvent is preferably 1 part by weight or more and 50 parts by weight or less based on 100 parts by weight of the solid content of the composition from the viewpoint of improving the coatability.

### Production Method

Next, a method of producing the composition will be described.

First, a method of producing graphene is described where the graphene is produced by a chemical exfoliation method.

The chemical exfoliation method preferably includes a step of exfoliating graphite by oxidation to obtain graphene oxide (graphite exfoliation step) and a step of performing reduction (reduction step) in this order. As necessary, a step of attaching a surface treatment agent to the graphene (surface treatment step) and/or a step of adjusting the size of the graphene in the direction parallel to a graphene layer (refinement step) may be included between the graphite exfoliation step and the reduction step. When surface-treated graphene is used, the surface treatment agent may be attached to graphene, or alternative may be attached to graphene oxide and then subjected to a reduction treatment to afford surface-treated graphene. When graphene is refined, graphene oxide may be refined, or alternatively graphene after reduction may be refined. From the viewpoint of uniformity of the reduction reaction, it is preferable to perform the reduction step in a state where the graphene oxide is refined, and the refinement step is preferably performed before the reduction step or in the middle of the reduction step. Therefore, it is preferable that the chemical exfoliation method includes the graphite exfoliation step, the surface treatment step, the refinement step, and the reduction step in this order. The method may further include a drying step of removing moisture, as necessary.

### Graphite Exfoliation Step

First, graphite is oxidatively exfoliated to afford graphene oxide. The degree of oxidation of the graphene oxide can be adjusted by changing the amount of an oxidizing agent to be used in the oxidation reaction of the graphite. Specifically, the degree of oxidation is higher as the amounts of sodium nitrate and potassium permanganate based on the graphite that are all used in the oxidation reaction are larger, whereas the degree of oxidation is lower as the amounts thereof are smaller. The weight ratio of sodium nitrate to graphite is preferably 0.200 or more and 0.800 or less. The ratio of potassium permanganate to graphite is preferably 1.00 or more and 4.0 or less.

### Surface Treatment Step

Next, the graphene oxide and the surface treatment agent are mixed, and the surface treatment agent is attached to graphene. Examples of a method of the mixing include a method of mixing using a mixer or a kneader such as an automatic mortar, a three-roll mill, a bead mill, a planetary ball mill, a homogenizer, a homodisper, a homomixer, a planetary mixer, or a twin-screw kneader.

### Refinement Step

Next, the graphene oxide is refined. Examples of the refinement method include a method in which a dispersion liquid to which pressure is applied is caused to collide against a single ceramic ball, a method using a liquid-liquid shear type wet jet mill with which dispersion is performed by colliding streams of a dispersion liquid to which pressure is applied against each other, and a method in which ultrasonic waves are applied to a dispersion liquid. In the refinement step, graphene oxide or graphene tends to be further refined as the treatment pressure and output are higher and graphene oxide or graphene tends to be further refined as the treatment time is longer. It is possible to prepare the size of graphene after reduction depending on the type of refinement treatment, treatment conditions, and treatment time in the refinement step. To adjust the size parallel to a graphene layer to the above-described range, the solid concentration of the graphene oxide or graphene in the refinement step is preferably 0.01% by weight or more and 2% by weight or less. When ultrasonic treatment is performed, the ultrasonic output is preferably 100 W or more and 3000 W or less.

### Reduction Step

Next, the refined graphene oxide is reduced. As the reduction method, chemical reduction is preferable. In chemical reduction, examples of the reducing agent include an organic reducing agent and an inorganic reducing agent, but an inorganic reducing agent is more preferable because of ease of washing after reduction.

Examples of the organic reducing agent include an aldehyde reducing agent, a hydrazine derivative reducing agent, and an alcohol reducing agent. Among them, an alcohol reducing agent is particularly suitable because it can reduce graphene oxide relatively mildly. Examples of the alcohol reducing agent include methanol, ethanol, propanol, isopropyl alcohol, butanol, benzyl alcohol, phenol, ethanolamine, ethylene glycol, propylene glycol, diethylene glycol and the like.

Examples of the inorganic reducing agent include sodium dithionite, potassium dithionite, phosphorous acid, sodium borohydride, hydrazine and the like. Among them, sodium dithionite and potassium dithionite are suitably used because they can reduce graphene oxide while relatively retaining acidic groups, so graphene having high dispersibility in a solvent can be produced.

By preferably performing a washing step of diluting the mixture with water and filtering the diluted mixture after completion of the reduction step, the purity of the graphene is improved.

### Drying Step

The graphene after completion of the reduction step can be powdered by diluting the graphene with water, freezing the diluted mixture, and drying the frozen mixture using a dryer such as a freeze dryer or a spray dryer.

Next, an example of a method for producing a composition using a graphene powder is described.

Examples thereof include a method of mixing a graphene powder with a curable resin and/or a precursor thereof, inorganic particles, and, as necessary, a solvent or an optional additive, and a method of mixing graphene with a commercially available coating composition including inorganic particles and a curable resin and/or a precursor thereof. In the former method, the inorganic particles and the graphene may be simultaneously added and mixed, or alternatively may be separately added and mixed. From the viewpoint of further enhancing the dispersibility of graphene, it is preferable to mix graphene and inorganic particles with a solution prepared by dissolving a curable resin and/or a precursor thereof in a solvent.

Examples of a mixing device include a mixer, a kneader or the like such as a bead mill, a homodisper, a homomixer, a planetary mixer, or a sand mill.

When the composition contains a curable resin precursor, the main agent (for example, a polyol) and a curing agent (for example, a curing agent for urethane resins) may be stored in separate containers until immediately before use. In this example, the graphene and the inorganic particles may be contained together with the main agent, or alternatively may be contained together with the curing agent. When the composition contains an epoxy resin and a curing agent for epoxy resins, the epoxy resin and the curing agent for epoxy resins may be stored in separate containers until immediately before use. In this example, the graphene and the inorganic particles may be contained together with the epoxy resin, or may be contained together with the curing agent for epoxy resins.

### Application of Composition

A second aspect is a coating material including the composition.

The composition can be suitably used for a protective coating material, and can also be used for applications utilizing the thermal conductivity, the electromagnetic wave shielding properties, and the effect of improving resin strength of graphene. By bringing the properties of the respective materials of the composition into the above-described ranges, these performances can be improved. Taking thermal conductivity as an example, graphene connects inorganic particles having thermal conductivity to form heat propagation paths, whereby thermal conductivity can be improved.

Examples of the protective coating material include an anti-corrosive coating material or an anti-rust coating material for preventing decay of a wooden substrate and corrosion of a metal substrate, a waterproof coating material to prevent infiltration of water, and a chemical resistant coating material to protect a substrate from degradation due to contact with chemicals. Among these, the composition and the protective coating material can be suitably used as an anti-rust coating material to prevent corrosion of a metal material due to rust.

A third aspect is a coating film formed by applying the coating material.

By applying the protective coating material including the composition, a coating film superior in corrosion resistance and durability can be obtained. The composition and the coating material can be suitably used as a coating film formed by applying the composition or the coating material onto a substrate and drying the composition or the coating material. Examples of an application method include applicator coating, bar coating, spin coating, roller coating, brush coating, and spray coating. A drying method can be appropriately selected according to the solvent, the resin, and the application, and examples thereof include natural drying, heat drying, and hot air drying.

The composition may be used, for example, by being injected into a crack and cured by drying and/or a crosslinking reaction. As the methods of injection and curing, known methods can be used.

A fourth aspect is a structure to which the coating material is applied.

By applying the coating material, a structure superior in corrosion resistance and durability can be obtained. Examples of the structure include infrastructures such as bridges, steel bridges, guardrails, and signs, industrial equipment such as plants, pipes, and steel pipes, vehicles such as ships, automobiles, railways, and aircrafts, metal housings such as electrical equipment, architectural structures such as buildings and houses, and metal products such as cans. From the viewpoint of being required for higher corrosion resistance, it is preferable to apply the coating material to an infrastructure, industrial equipment, or a vehicle. It is further preferable to apply the coating material to a structure that is exposed to a strongly corrosive environment such as a seashore area.

A cured product obtained by curing the composition is superior in corrosion resistance and durability. As one of indices of corrosion resistance, it is preferable that the water vapor transmission rate and the oxygen transmission rate are low. Specifically, the water vapor transmission rate measured by the method described in Measurement Example 6 of EXAMPLES described later is preferably 300 g/m2·24 h or less, more preferably 250 g/m2·24 h or less, and still more preferably 225 g/m2·24 h or less. Since water serves as a carrier of oxygen, the oxygen transmission rate tends to decrease as the water vapor transmission rate decreases.

As another index of corrosion resistance, it is preferable that the corrosion potential representing the difficulty in corrosion occurrence is low. Specifically, the corrosion potential measured by the method described in Measurement Example 7 of EXAMPLES described later is preferably −0.9 V or less, and more preferably −1.0 V or less.

As an index of durability, it is preferable that the time taken until the time when the score reaches 3 (the width of red rust at the cut portion is 2 mm) when a salt spray resistance test is performed by the method described in Measurement Example 8 of EXAMPLES described later is longer. The time to reach score 3 in a salt spray resistance test is greatly extended in the presence of a sacrificial anti-corrosion effect by zinc. Therefore, when the composition does not contain zinc, the time to reach score 3 in a salt spray resistance test is preferably 500 h or more, more preferably 600 h or more, and still more preferably 700 h or more. On the other hand, when the composition contains zinc, the time to reach score 3 in a salt spray resistance test is preferably 1,400 h or more, more preferably 2,000 h or more, and still more preferably 3,000 h or more.

### EXAMPLES

In the following, our composition will be described by way of examples. First, evaluation methods in each Example and Comparative Example are described.

### Measurement Example 1: Average Thickness of Graphene

The composition prepared in each of Examples and Comparative Examples was diluted 10 times with N-methylpyrrolidone, then treated with a HOMOGENIZING DISPER Model 2.5 (PRIMIX Corporation) at a rotation speed of 3,000 rpm for 30 minutes, and thus a diluted liquid was prepared. The diluted liquid was passed through a mesh filter having a mesh size with which inorganic particles can be removed, and thus inorganic particles were removed. The filtrate obtained was filtered using filter paper, and graphene was recovered. The recovered graphene was washed 5 times with 20 mL of N-methylpyrrolidone. The washed graphene was diluted to 0.01% by weight, treated with a “FILMIX” (registered trademark) Model 30-30 (PRIMIX Corporation) at a rotation speed of 40 m/s (shear rate: 20,000 per second) for 60 seconds, and thus a graphene diluted liquid was obtained. The graphene diluted liquid was dropped onto a mica substrate, dried and thus graphene was attached to the substrate. The graphene on the substrate was observed with an atomic force microscope (Dimension Icon; available from Bruker Corporation) in an enlarged manner in a square field of view of about 1 to 10 μm on each side, and for 10 pieces of the graphene randomly selected, the thickness was measured. The thickness of each piece of the graphene was defined by an arithmetic average value of values of thicknesses measured at five points randomly selected for each piece of the graphene. The average thickness of the graphene was calculated by determining the arithmetic average value of the thicknesses of 10 pieces of the graphene.

### Measurement Example 2: Size in Direction Parallel to Graphene Layer (Rb) of Graphene

A graphene diluted liquid was prepared in the same manner as in Measurement Example 1, and the graphene diluted liquid was dropped onto a mica substrate, dried, and thus graphene was attached to the substrate. The graphene on the substrate was observed in an enlarged manner at 30,000 magnifications using an electron microscope S-5500 (manufactured by Hitachi High-Technologies Corporation). The length of a longest part (major axis) and the length of a shortest part (minor axis) in a direction parallel to a graphene layer were measured for each of 10 pieces of the graphene randomly selected. An arithmetic average value of numerical values calculated by (major axis+minor axis)/2 was determined, and thus the size in the direction parallel to a graphene layer was calculated.

### Measurement Example 3: O/C Ratio and N/C Ratio by X-Ray Photoelectron Spectroscopy

The surface-treated graphene powder prepared in each of Examples and Comparative Examples was subjected to photoelectron spectrum measurement using an X-ray photoelectron spectrometer Quantera SXM (manufactured by ULVAC-PHI, Inc.). The excited X-ray was monochromatic Al Kα1,2 rays (1486.6 eV), the X-ray diameter was 200 μm, and the photoelectron escape angle was 45°. A C1s main peak originating from carbon atoms was assigned to 284.3 eV, an O1s peak originating from oxygen atoms was assigned to a peak near 533 eV, an N1s peak originating from nitrogen atoms was assigned to a peak near 402 eV. An O/C ratio is calculated from the area ratio of the O1s peak to the C1s peak, and the resulting value was rounded off to the second decimal place. In addition, an N/C ratio is calculated from the area ratio of the N1s peak to the C1s peak, and the resulting value was rounded off to the third decimal place. Since there is no difference in the O/C ratio and the N/C ratio of graphene between a composition and a graphene dispersion liquid, analysis was performed using the graphene dispersion liquid.

### Measurement Example 4: Average Particle Size (Ra) of Inorganic Particles

The composition prepared in each of Examples and Comparative Examples was diluted 100 times with N-methylpyrrolidone, then treated with a HOMOGENIZING DISPER Model 2.5 (PRIMIX Corporation) at a rotation speed of 3,000 rpm for 30 minutes, and thus a diluted liquid was prepared. 20 mL of the diluted liquid was filtered using filter paper, and then an operation of washing the obtained filtration residue by pouring 20 mL of N-methylpyrrolidone thereon was repeated 5 times, and thus the resin component was removed and a mixture of inorganic particles and graphene was obtained. The mixture of inorganic particles and graphene was diluted to 0.01% by weight, treated with a “FILMIX” (registered trademark) Model 30-30 (PRIMIX Corporation) at a rotation speed of 40 m/s (shear rate: 20,000 per second) for 60 seconds, and thus a particle redispersion liquid was obtained. The particle redispersion liquid was dropped onto a mica substrate, dried, and thus the inorganic particles and the graphene were attached to the substrate. The inorganic particles on the substrate were observed with an electron microscope S-5500 (manufactured by Hitachi High-Technologies Corporation) in an enlarged manner at 1,500 to 50,000 magnifications such that the inorganic particles appropriately captured in the field of view, and 20 inorganic particles randomly selected were photographed. It is noted that for scaly or flaky flat particles such as bentonite and stainless steel flakes, 20 inorganic particles selected from among particles whose largest area face faced the observation direction were photographed. For spherical particles such as zinc particles, irregularly shaped particles, fibrous particles, and flat particles, the length of the longest part (major axis) and the length of the shortest part (minor axis) in the observation image were measured. The average particle size (Ra) of inorganic particles was calculated by determining the arithmetic average value of the numerical values obtained by (major axis+minor axis)/2 of the respective particle measured as described above.

### Measurement Example 5: Number of Defects

The composition produced in each of Examples and Comparative Examples was applied onto an A4-sized 50 μm-thick PET film using a spray, then dried at room temperature, and left at rest and cured for 1 week, forming a cured film 100 μm in thickness. The surface of the resulting cured film was observed with an optical microscope in an enlarged manner at 100 magnifications, and the presence or absence of defects such as cracks and holes (pinholes) was observed at 10 places randomly selected, and the corrosion resistance was evaluated on the basis of the number of places where defects were recognized. The smaller the number of places where defects are recognized, the better the corrosion resistance.

### Measurement Example 6: Water Vapor Transmission Rate

A cured film having a thickness of 100 μm was formed on an A4-sized 50 μm-thick PET film in the same manner as in Measurement Example 5. The cured film was then peeled off with the cured film surface facing downward and the PET film side being pulled up. The resulting cured film was cut into a 12 cm square, and a portion coming into contact with a packing of a chamber was protected with an aluminum tape and installed in a water vapor transmission rate analyzer PERMATRAN-W 3/33 MG+ manufactured by MOCON, Inc. The water vapor transmission rate was measured under the conditions specified by an equal pressure method, a chamber internal temperature of 20° C., and a relative humidity of 90%. The lower the water vapor transmission rate, the better the corrosion resistance.

### Measurement Example 7: Corrosion Potential

The composition prepared in each of Examples and Comparative Examples was applied to a sandblasted rolled steel sheet for general structure (material: SS400) having a size of 15 cm×7 cm×0.25 cm in thickness using a spray gun, dried at room temperature, and left at rest for 1 day, forming a cured film. The thickness of the cured film was adjusted to 80±10 μm. A commercially available anti-rust coating material (“ZINKY” (registered trademark) 8000 HB manufactured by Nippon Paint Co., Ltd.) was applied with a brush to an exposed portion of the substrate where the cured film was not formed, dried, and then left at rest for 1 week to cure. Thus, a test plate was obtained. The test plate was connected to a working electrode of a potentiostat Model 1480A manufactured by Solartron Analytical, a platinum electrode was connected to a counter electrode, and a silver-silver chloride electrode was connected to a reference electrode. The test plate was immersed in 300 mL of a 3.5% by weight aqueous sodium chloride solution (pH=7) at room temperature placed in a 500 ml beaker, and measurement was started. In the measurement, the condition was first stabilized on an Open Circuit for an initial 900 seconds, then sweeping was performed from −0.2 V to +0.5 V at a rate of 0.003 V/s in a voltage sweep mode, and the current value was measured. The absolute value of the current value obtained was plotted, and the voltage at which the current value became minimum was defined as a corrosion potential. The lower the corrosion potential (the larger the absolute value), the better the corrosion resistance.

### Measurement Example 8: Salt Spray Time

A test plate was obtained in the same manner as in Measurement Example 7. A linear cut having a length of 5 cm and a depth of 0.5 to 1.0 mm was made in the central part of the test plate, and the test plate was set in a salt spray tester (HAIDA HD-E808-120). A salt spray test was started using a 5% by weight aqueous sodium chloride solution (pH=7) heated to 35° C. Then, scoring was performed as follows according to the rust generation state of each sample, and the change with time of the state was recorded. The durability was evaluated on the basis of the time when the score reached 3.
Score 0: It is close to the initial state, and red rust is not observed. When zinc is used, white rust is observed due to the sacrificial anti-corrosion effect, but red rust is not observed.
Score 1: Red rust is observed at the entire cut portion.
Score 2: Red rust having a width of less than 2 mm is observed at the entire cut portion, and there is one or more places where blister of the cured film occurs around the cut portion or pitting corrosion occurs at a portion other than the cut portion and red rust is observed.
Score 3: A plurality of blisters or pitting corrosions are observed around the cut portion, and the width of red rust at the cut portion is 2 mm or more.

### Synthesis Example 1: Preparation of Graphene Oxide

With 1500 mesh natural graphite powder (Shanghai Yifan Graphite Co., Ltd.) as a raw material, 220 ml of 98% concentrated sulfuric acid, 5 g of sodium nitrate, and 30 g of potassium permanganate were charged into 10 g of the natural graphite powder in an ice bath. The liquid mixture was mechanically stirred for 1 hour while the temperature of the liquid mixture was kept at 20° C. or lower. The liquid mixture was taken out from the ice bath, and stirred in a water bath at 35° C. for 4 hours. Then, 500 ml of ion-exchanged water was added, and the resulting suspension was stirred at 90° C. for additional 15 minutes. Finally, 600 ml of ion-exchanged water and 50 ml of hydrogen peroxide were charged into the suspension, and the mixture was stirred for 5 minutes, affording a graphene oxide dispersion liquid. This liquid was filtered while it was hot, metal ions were washed with a dilute hydrochloric acid solution, the acid was washed with ion-exchanged water, and the washing was repeated until the pH reached 7. The resulting mixture was concentrated by suction filtration, and a 45% by weight graphene oxide wet cake was thereby prepared. The element ratio of oxygen atoms to carbon atoms (O/C ratio) of the prepared graphene oxide measured by X-ray photoelectron spectroscopy was 0.53.

### Example 1

### Preparation of Surface-Treated Graphene

11.1 g (solid: 5 g) of the 45% by weight graphene oxide wet cake prepared in Synthesis Example 1 was diluted to a concentration of 0.5% by weight using 988.9 g of ion-exchanged water, and treated with a HOMOGENIZING DISPER Model 2.5 (PRIMIX Corporation) at a rotation speed of 3,000 rpm for 30 minutes, affording a uniform graphene oxide dispersion liquid. Sodium hydroxide was added to adjust the pH to 8.5, 2.5 g of dopamine hydrochloride manufactured by Tokyo Chemical Industry Co., Ltd. was mixed as a surface treatment agent, and the resulting mixture was treated with a HOMOGENIZING DISPER Model 2.5 (PRIMIX Corporation) at a rotation speed of 3,000 rpm for 60 minutes. Furthermore, the mixture was treated with a FILMIX (registered trademark) Model 30-30 (PRIMIX Corporation) at a rotation speed of 40 m/s (shear rate: 20,000/sec) for 180 seconds. To the resulting graphene oxide dispersion liquid was added 25 g of sodium dithionite, and the resulting mixture was reduced by being stirred on a water bath at 40° C. with a HOMOGENIZING DISPER Model 2.5 (PRIMIX Corporation) at a rotation speed of 2,000 rpm for 1 hour. Then, the mixture was filtered with a vacuum suction filter, and furthermore the resulting solid was washed by repeating five times a washing step of diluting the solid to 0.5% by mass with water and subjecting the diluted liquid to suction filtration, affording a graphene-water wet cake. The graphene-water wet cake obtained was diluted with water to have a concentration of 1% by weight, and placed in an eggplant flask. The diluted liquid was frozen by cooling the eggplant flask with liquid nitrogen, and then freeze-dried overnight using a freeze dryer FDU-1200 manufactured by EYELA, affording a graphene powder. The O/C ratio and the N/C ratio of the graphene were measured by the method described in Measurement Example 3, and the results are shown in Table 2.

### Preparation of Composition

32.45 g of “EPICLON” (registered trademark) 1050 (bisphenol A epoxy resin, epoxy equivalent: 450 to 500 g/eq) manufactured by DIC Corporation was weighed as an epoxy resin, and 30 g of xylene and 2.4 g of n-butanol were added thereto, and the resulting mixture was heated to 90° C. to dissolve the epoxy resin, and then the mixture was stirred with a HOMOGENIZING DISPER Model 2.5 (PRIMIX Corporation) at a rotation speed of 3,000 rpm for 20 minutes. To the resulting solution were added 30 g of a zinc powder (average particle size: 10 μm) manufactured by Hayashi Pure Chemical Ind., Ltd., 5 g of bentonite manufactured by FUJIFILM Wako Pure Chemical Corporation, and 0.1 g of the graphene powder (0.1% by weight based on the total solid content) obtained by the above-described method, and the resulting mixture was stirred with a HOMOGENIZING DISPER Model 2.5 (PRIMIX Corporation) at a rotation speed of 3,000 rpm for 30 minutes. To the resulting mixture was added 46.36 g of NEWMIDE 515 (trade name) manufactured by Harima Chemicals Group, Inc. (polyamide amine, active hydrogen equivalent: 185, solid content: 70% by weight, solid weight: 32.45 g) as a curing agent for epoxy resins. The resulting mixture was homogenized by further stirring with a HOMOGENIZING DISPER Model 2.5 (PRIMIX Corporation) at a rotation speed of 3,000 rpm for 10 minutes, and a composition was thereby prepared. The content of inorganic particles in the composition obtained was 35% by weight based on the total solid content of the composition.

For the composition obtained, the average thickness and the size of the graphene in the direction parallel to a graphene layer were measured by the methods described in Measurement Examples 1 and 2, and the results are shown in Table 2.

Using the composition obtained, corrosion resistance and durability were evaluated by the methods described in Measurement Examples 5 to 8, and the results are shown in Table 3.

### Example 2

A graphene powder was obtained in the same manner as in Example 1 except that the surface treatment agent was changed to 3-chloroaniline manufactured by Tokyo Chemical Industry Co., Ltd. in the preparation of the surface-treated graphene. Using the graphene powder obtained, a composition was prepared and evaluated in the same manner as in Example 1.

### Example 3

A graphene powder was obtained in the same manner as in Example 1 except that the surface treatment agent was changed to aniline hydrochloride manufactured by Thermo Scientific Inc. in the preparation of the surface-treated graphene. Using the graphene powder obtained, a composition was prepared and evaluated in the same manner as in Example 1.

### Example 4

A graphene powder was obtained in the same manner as in Example 1 except that the surface treatment agent was changed to 1-aminopyrene manufactured by Tokyo Chemical Industry Co., Ltd. in the preparation of the surface-treated graphene. Using the graphene powder obtained, a composition was prepared and evaluated in the same manner as in Example 1.

### Example 5

A composition was prepared and evaluated in the same manner as in Example 1 except that the amount of the graphene powder was changed to 0.03 g (0.03% by weight based on the total solid content) in the preparation of the composition.

### Example 6

A composition was prepared and evaluated in the same manner as in Example 1 except that the amount of the graphene powder was changed to 0.07 g (0.07% by weight based on the total solid content) in the preparation of the composition.

### Example 7

A composition was prepared and evaluated in the same manner as in Example 1 except that the amount of the graphene powder was changed to 0.5 g (0.5% by weight based on the total solid content), the amount of “EPICLON” (registered trademark) 1050 was changed to 32.25 g, and the amount of NEWMIDE 515 (trade name) was changed to 46.07 g in the preparation of the composition.

### Example 8

A composition was prepared in the same manner as in Example 1 and evaluated in the same manner as in Example 1 except that the amount of the graphene powder was changed to 0.7 g (0.7% by weight based on the total solid content), the amount of “EPICLON” (registered trademark) 1050 was changed to 32.15 g, and the amount of NEWMIDE 515 (trade name) was changed to 45.93 g in the preparation of the composition.

### Example 9

A composition was prepared in the same manner as in Example 1 except that the amount of “EPICLON” (registered trademark) 1050 was changed to 17.45 g, the amount of the zinc powder was changed to 60 g, the amount of bentonite was changed to 5 g, and the amount of NEWMIDE 515 (trade name) was changed to 24.93 g in the preparation of the composition. The content of the inorganic particles in the composition obtained was 65% by weight based on the total solid content of the composition. The composition obtained was evaluated in the same manner as in Example 1.

### Example 10

A composition was prepared in the same manner as in Example 1 except that the amount of “EPICLON” (registered trademark) 1050 was changed to 22.45 g, the amount of the zinc powder was changed to 50 g, the amount of bentonite was changed to 5 g, and the amount of NEWMIDE 515 (trade name) was changed to 32.07 g in the preparation of the composition. The content of the inorganic particles in the composition obtained was 55% by weight based on the total solid content of the composition. The composition obtained was evaluated in the same manner as in Example 1.

### Example 11

A composition was prepared in the same manner as in Example 1 except that the amount of “EPICLON” (registered trademark) 1050 was changed to 27.4 g, the amount of the zinc powder was changed to 40 g, the amount of bentonite was changed to 5 g, the amount of the graphene powder was changed to 0.2 g, and the amount of NEWMIDE 515 (trade name) was changed to 39.14 g in the preparation of the composition. The content of the inorganic particles in the composition obtained was 45% by weight based on the total solid content of the composition. The composition obtained was evaluated in the same manner as in Example 1.

### Example 12

In the preparation of a composition, 13 g of a zinc powder and 2 g of silicon dioxide were mixed with 35 g of isopropyl alcohol, 0.4 g (0.4% by weight based on the total solid content) of a graphene powder obtained in the same manner as in Example 1 was added, and the mixture was stirred with a HOMOGENIZING DISPER Model 2.5 (PRIMIX Corporation) at a rotation speed of 3,000 rpm for 20 minutes under the condition of a liquid temperature of 20° C. using a water-cooled jacket. Thereafter, to the resulting mixture was added 27.4 g of amorphous silica and 55 g of tetraethoxysilane manufactured by Tokyo Chemical Industry Co., Ltd. as silicate resins. The mixture was homogenized by further stirring with a HOMOGENIZING DISPER Model 2.5 (PRIMIX Corporation) at a rotation speed of 3,000 rpm for 10 minutes, and a composition was thereby prepared. The content of the inorganic particles in the composition was 15% by weight based on the total solid content of the composition. The composition obtained was evaluated in the same manner as in Example 1.

### Example 13

A composition was prepared in the same manner as in Example 12 except that the amount of the zinc powder was changed to 7 g, the amount of silicon dioxide was changed to 1 g, the amount of the graphene powder was changed to 0.5 g, the amount of amorphous silica was changed to 45.75 g, and the amount of tetraethoxysilane was changed to 90 g in the preparation of the composition. The content of the inorganic particles in the composition was 8% by weight based on the total solid content of the composition. The composition obtained was evaluated in the same manner as in Example 1.

### Example 14

A composition was prepared in the same manner as in Example 12 except that the amount of the zinc powder was changed to 3.5 g, the amount of silicon dioxide was changed to 0.5 g, the amount of the graphene powder was changed to 0.9 g, the amount of amorphous silica was changed to 47.5 g, and the amount of tetraethoxysilane was changed to 100 g in the preparation of the composition. The content of the inorganic particles in the composition was 4% by weight based on the total solid content of the composition. The composition obtained was evaluated in the same manner as in Example 1.

### Example 15

A composition was prepared and evaluated in the same manner as in Example 1 except that the use amount of sodium dithionite was changed to 2.5 g in the preparation of the surface-treated graphene.

### Example 16

A composition was prepared and evaluated in the same manner as in Example 1 except that in the preparation of surface-treated graphene, a step of applying ultrasonic waves at an output of 300 W for 10 minutes using an ultrasonic device UP400S (Hielscher) after the treatment with “FILMIX” (registered trademark) Model 30-30 (PRIMIX Corporation) (refinement step) was added.

### Example 17

A composition was prepared and evaluated in the same manner as in Example 1 except that in the preparation of surface-treated graphene, a step of applying ultrasonic waves at an output of 300 W for 30 minutes using an ultrasonic device UP400S (Hielscher) after the treatment with “FILMIX” (registered trademark) Model 30-30 (PRIMIX Corporation) (refinement step) was added.

### Example 18

A composition was prepared and evaluated in the same manner as in Example 1 except that in the preparation of surface-treated graphene, a step of applying ultrasonic waves at an output of 300 W for 60 minutes using an ultrasonic device UP400S (Hielscher) after the treatment with “FILMIX” (registered trademark) Model 30-30 (PRIMIX Corporation) (refinement step) was added.

### Example 19

A graphene powder was prepared in the same manner as in Example 1 except that the surface treatment agent was changed to 5 g of triethylenetetramine manufactured by Tokyo Chemical Industry Co., Ltd. in the preparation of the surface-treated graphene. Using the graphene powder obtained, a composition was prepared and evaluated in the same manner as in Example 1.

### Example 20

A graphene powder was prepared in the same manner as in Example 1 except that the surface treatment agent was changed to 10 g of “EPOMIN” SP-18 manufactured by Nippon Shokubai Co., Ltd. in the preparation of the surface-treated graphene. Using the graphene powder obtained, a composition was prepared and evaluated in the same manner as in Example 1.

### Comparative Example 1

A composition was prepared and evaluated in the same manner as in Example 1 except that the graphene powder was not used in the preparation of the composition.

### Comparative Example 2

A composition was prepared and evaluated in the same manner as in Example 9 except that the graphene powder was not used in the preparation of the composition.

### Comparative Example 3

A composition was prepared and evaluated in the same manner as in Example 10 except that the graphene powder was not used in the preparation of the composition.

### Comparative Example 4

A composition was prepared and evaluated in the same manner as in Example 11 except that the graphene powder was not used in the preparation of the composition.

### Comparative Example 5

A composition was prepared and evaluated in the same manner as in Example 12 except that the graphene powder was not used and the amount of amorphous silica was changed to 27.8 g in the preparation of the composition.

### Comparative Example 6

A composition was prepared and evaluated in the same manner as in Example 13 except that the graphene powder was not used and the amount of amorphous silica was changed to 48.25 g in the preparation of the composition.

### Comparative Example 7

A composition was prepared and evaluated in the same manner as in Example 14 except that the graphene powder was not used and the amount of amorphous silica was changed to 48.4 g in the preparation of the composition.

### Comparative Example 8

A composition was prepared and evaluated in the same manner as in Example 1 except that the surface treatment agent was not used and the treatment with “FILMIX” (registered trademark) Model 30-30 was not performed in the preparation of the surface-treated graphene.

### Example 21

A graphene powder was prepared in the same manner as in Example 1. A composition was prepared and evaluated in the same manner as in Example 1 except that stainless steel flakes (average particle size: 30 μm) manufactured by Toyo Aluminium K.K. were used in place of the zinc powder in the preparation of the composition.

### Example 22

A composition was prepared and evaluated in the same manner as in Example 1 except that aluminum flakes (average particle size: 30 μm) were used in place of the zinc powder in the preparation of the composition.

### Example 23

A composition was prepared and evaluated in the same manner as in Example 1 except that a wet ground mica powder (average particle size: 22 μm) manufactured by Matsuo Sangyo Co., Ltd. was used in place of the zinc powder in the preparation of the composition.

### Example 24

A graphene powder was prepared in the same manner as in Example 1 except that the surface treatment agent was changed to 1,4-phenylenediamine manufactured by Tokyo Chemical Industry Co., Ltd. in the preparation of the surface-treated graphene.

### Preparation of Composition

7.45 g of “EPICLON” 1050 manufactured by DIC Corporation was weighed as an epoxy resin, and 18 g of xylene and 2 g of n-butanol were added thereto, and the resulting mixture was heated to 90° C. to dissolve the epoxy resin, and then the mixture was stirred with a HOMOGENIZING DISPER Model 2.5 (PRIMIX Corporation) at a rotation speed of 3,000 rpm for 20 minutes. To the solution obtained were added 82 g of stainless steel flakes (average particle size: 30 μm) manufactured by Toyo Aluminium K.K. and 0.1 g (0.1% by weight based on the total solid weight) of a graphene powder, and the mixture was stirred with a HOMOGENIZING DISPER Model 2.5 (PRIMIX Corporation) at a rotation speed of 3,000 rpm for 30 minutes. To the resulting mixture was added 10.6 g of NEWMIDE 515 (trade name) manufactured by Harima Chemicals Group, Inc. (solid content: 70% by weight, solid weight: 7.45 g) as a curing agent for epoxy resins, and 3.0 g of bentonite was added. The resulting mixture was homogenized by further stirring with a HOMOGENIZING DISPER Model 2.5 (PRIMIX Corporation) at a rotation speed of 3,000 rpm for 10 minutes, and a composition was thereby prepared. The composition obtained was evaluated in the same manner as in Example 1.

### Example 25

A composition was prepared and evaluated in the same manner as in Example 24 except that the addition amount of the epoxy resin was changed to 16.2 g, the addition amount of xylene was changed to 36 g, the addition amount of n-butanol was changed to 4 g, the addition amount of the curing agent for epoxy resins was changed to 23.1 g (solid content: 70% by weight, solid weight: 16.2 g), the addition amount of bentonite was changed to 3.5 g, and 64 g of aluminum flakes (average particle size: 30 μm) was added in place of the stainless steel flakes in the preparation of the composition.

### Example 26

A composition was produced and evaluated in the same manner as in Example 24 except that the addition amount of the epoxy resin was changed to 15.95 g, the addition amount of xylene was changed to 36 g, the addition amount of n-butanol was changed to 4 g, the addition amount of the curing agent for epoxy resins was changed to 22.79 g (solid content: 70% by weight, solid weight: 15.95 g), and 65 g of a wet ground mica powder (average particle size: 22 μm) manufactured by Matsuo Sangyo Co., Ltd. was added in place of the aluminum flakes in the preparation of the composition.

### Comparative Example 9

A composition was prepared and evaluated in the same manner as in Example 21 except that the graphene powder was not used.

### Comparative Example 10

A composition was prepared and evaluated in the same manner as in Example 22 except that the graphene powder was not used.

### Comparative Example 11

A composition was prepared and evaluated in the same manner as in Example 23 except that the graphene powder was not used.

### Comparative Example 12

A composition was prepared and evaluated in the same manner as in Example 24 except that the graphene powder was not used.

The compositions and evaluation results of Examples and Comparative Examples are shown in Tables 1 to 6.

TABLE 1

| | Composition | | | |
|---|---|---|---|---|
| | Curable | Inorganic particle | | |
| | resin/ | Content | | Ra*1 |
| | Precursor | (wt %) | Type | (μm) |
| Example 1 | Epoxy resin | 35 | Zinc, Bentonite | 10 |
| Example 2 | Epoxy resin | 35 | Zinc, Bentonite | 10 |
| Example 3 | Epoxy resin | 35 | Zinc, Bentonite | 10 |
| Example 4 | Epoxy resin | 35 | Zinc, Bentonite | 10 |
| Example 5 | Epoxy resin | 35 | Zinc, Bentonite | 10 |
| Example 6 | Epoxy resin | 35 | Zinc, Bentonite | 10 |
| Example 7 | Epoxy resin | 35 | Zinc, Bentonite | 10 |
| Example 8 | Epoxy resin | 35 | Zinc, Bentonite | 10 |
| Example 9 | Epoxy resin | 65 | Zinc, Bentonite | 10 |
| Example 10 | Epoxy resin | 55 | Zinc, Bentonite | 10 |
| Example 11 | Epoxy resin | 45 | Zinc, Bentonite | 10 |
| Example 12 | Silicate resin | 15 | Zinc, Silicon dioxide | 10 |
| Example 13 | Silicate resin | 8 | Zinc, Silicon dioxide | 10 |
| Example 14 | Silicate resin | 4 | Zinc, Silicon dioxide | 10 |
| Example 15 | Epoxy resin | 35 | Zinc, Bentonite | 10 |
| Example 16 | Epoxy resin | 35 | Zinc, Bentonite | 10 |
| Example 17 | Epoxy resin | 35 | Zinc, Bentonite | 10 |
| Example 18 | Epoxy resin | 35 | Zinc, Bentonite | 10 |
| Example 19 | Epoxy resin | 35 | Zinc, Bentonite | 10 |
| Example 20 | Epoxy resin | 35 | Zinc, Bentonite | 10 |
| Comparative | Epoxy resin | 35 | Zinc, Bentonite | 10 |
| Example 1 | | | | |
| Comparative | Epoxy resin | 65 | Zinc, Bentonite | 10 |
| Example 2 | | | | |
| Comparative | Epoxy resin | 55 | Zinc, Bentonite | 10 |
| Example 3 | | | | |
| Comparative | Epoxy resin | 45 | Zinc, Bentonite | 10 |
| Example 4 | | | | |
| Comparative | Silicate resin | 15 | Zinc, Silicon dioxide | 10 |
| Example 5 | | | | |
| Comparative | Silicate resin | 8 | Zinc, Silicon dioxide | 10 |
| Example 6 | | | | |
| Comparative | Silicate resin | 4 | Zinc, Silicon dioxide | 10 |
| Example 7 | | | | |
| Comparative | Epoxy resin | 35 | Zinc, Bentonite | 10 |
| Example 8 | | | | |

*1Average particle size of inorganic particles

TABLE 2

| | Composition | | | | | | |
|---|---|---|---|---|---|---|---|
| | Graphene | | | | | | |
| | Content based | | | | | | |
| | on total | Average | | | | | Particle |
| | solid weight | thickness | Rb*2 | | O/C | N/C | size ratio |
| | (% by weight) | (nm) | (μm) | Surface treatment agent | ratio | Ratio | Ra/Rb |
| Example 1 | 0.1 | 3.2 | 10 | Dopamine hydrochloride | 0.13 | 0.016 | 1.0 |
| Example 2 | 0.1 | 5.1 | 10 | 3-Chloroaniline | 0.13 | 0.035 | 1.0 |
| | | | | hydrochloride | | | |
| Example 3 | 0.1 | 9.8 | 10 | Aniline hydrochloride | 0.13 | 0.006 | 1.0 |
| Example 4 | 0.1 | 14 | 10 | 1-Aminopyrene | 0.13 | 0.004 | 1.0 |
| | | | | hydrochloride | | | |
| Example 5 | 0.03 | 3.2 | 10 | Dopamine hydrochloride | 0.13 | 0.016 | 1.0 |
| Example 6 | 0.07 | 3.2 | 10 | Dopamine hydrochloride | 0.13 | 0.016 | 1.0 |
| Example 7 | 0.5 | 3.2 | 10 | Dopamine hydrochloride | 0.13 | 0.016 | 1.0 |
| Example 8 | 0.7 | 3.2 | 10 | Dopamine hydrochloride | 0.13 | 0.016 | 1.0 |
| Example 9 | 0.1 | 3.2 | 10 | Dopamine hydrochloride | 0.13 | 0.016 | 1.0 |
| Example 10 | 0.1 | 3.2 | 10 | Dopamine hydrochloride | 0.13 | 0.016 | 1.0 |
| Example 11 | 0.2 | 3.2 | 10 | Dopamine hydrochloride | 0.13 | 0.016 | 1.0 |
| Example 12 | 0.4 | 3.2 | 10 | Dopamine hydrochloride | 0.13 | 0.016 | 1.0 |
| Example 13 | 0.5 | 3.2 | 10 | Dopamine hydrochloride | 0.13 | 0.016 | 1.0 |
| Example 14 | 0.9 | 3.2 | 10 | Dopamine hydrochloride | 0.13 | 0.016 | 1.0 |
| Example 15 | 0.1 | 4.1 | 10 | Dopamine hydrochloride | 0.32 | 0.004 | 1.0 |
| Example 16 | 0.1 | 2.8 | 3.1 | Dopamine hydrochloride | 0.13 | 0.016 | 3.2 |
| Example 17 | 0.1 | 2.5 | 2.4 | Dopamine hydrochloride | 0.13 | 0.016 | 4.2 |
| Example 18 | 0.1 | 3.1 | 1.3 | Dopamine hydrochloride | 0.13 | 0.016 | 7.7 |
| Example 19 | 0.1 | 27 | 21 | Triethylenetetramine | 0.07 | 0.112 | 0.5 |
| Example 20 | 0.1 | 42 | 54 | EPOMIN (registered | 0.03 | 0.224 | 0.2 |
| | | | | trademark) SP-018 | | | |
| Comparative | Absent | Absent | Absent | Absent | Absent | Absent | Absent |
| Example 1 | | | | | | | |
| Comparative | Absent | Absent | Absent | Absent | Absent | Absent | Absent |
| Example 2 | | | | | | | |
| Comparative | Absent | Absent | Absent | Absent | Absent | Absent | Absent |
| Example 3 | | | | | | | |
| Comparative | Absent | Absent | Absent | Absent | Absent | Absent | Absent |
| Example 4 | | | | | | | |
| Comparative | Absent | Absent | Absent | Absent | Absent | Absent | Absent |
| Example 5 | | | | | | | |
| Comparative | Absent | Absent | Absent | Absent | Absent | Absent | Absent |
| Example 6 | | | | | | | |
| Comparative | Absent | Absent | Absent | Absent | Absent | Absent | Absent |
| Example 7 | | | | | | | |
| Comparative | 0.1 | 126 | 18 | Absent | 0.03 | Absent | 0.6 |
| Example 8 | | | | | | | |

*2Size of graphene in direction parallel to graphene layer

TABLE 3

| | Evaluation results | | | |
|---|---|---|---|---|
| | Corrosion resistance | | | Durability |
| | Number | Water vapor | Corrosion | Time to reach score |
| | of | transmission rate | potential | 3 in salt spray |
| | defects | (g/m² · 24 h) | (V) | resistance test (h) |
| Example 1 | 0 | 121 | −1.2 | 3160 |
| Example 2 | 0 | 126 | −1.2 | 3220 |
| Example 3 | 0 | 129 | −1.2 | 3100 |
| Example 4 | 0 | 135 | −1.2 | 3040 |
| Example 5 | 0 | 141 | −1.0 | 2520 |
| Example 6 | 0 | 139 | −1.1 | 2680 |
| Example 7 | 0 | 118 | −1.2 | 3200 |
| Example 8 | 0 | 115 | −1.2 | 3200 |
| Example 9 | 0 | 165 | −1.2 | 5400 |
| Example 10 | 0 | 156 | −1.2 | 4800 |
| Example 11 | 0 | 152 | −1.2 | 3900 |
| Example 12 | 0 | 112 | −1.1 | 2640 |
| Example 13 | 0 | 109 | −1.0 | 1440 |
| Example 14 | 0 | 108 | −0.7 | 920 |
| Example 15 | 0 | 124 | −1.0 | 2460 |
| Example 16 | 0 | 123 | −1.2 | 3100 |
| Example 17 | 0 | 126 | −1.2 | 3040 |
| Example 18 | 0 | 138 | −0.9 | 2640 |
| Example 19 | 1 | 141 | −0.9 | 2420 |
| Example 20 | 1 | 155 | −0.9 | 2120 |
| Comparative | 0 | 143 | −0.6 | 720 |
| Example 1 | | | | |
| Comparative | 2 | 185 | −0.8 | 1440 |
| Example 2 | | | | |
| Comparative | 2 | 179 | −0.7 | 1200 |
| Example 3 | | | | |
| Comparative | 1 | 164 | −0.7 | 960 |
| Example 4 | | | | |
| Comparative | 0 | 133 | −0.6 | 540 |
| Example 5 | | | | |
| Comparative | 0 | 125 | −0.6 | 480 |
| Example 6 | | | | |
| Comparative | 0 | 122 | −0.6 | 460 |
| Example 7 | | | | |
| Comparative | 3 | 233 | −0.7 | 840 |
| Example 8 | | | | |

TABLE 4

| | Composition | | | |
|---|---|---|---|---|
| | Curable | Inorganic particle | | |
| | resin/ | Content | | Ra*1 |
| | Precursor | (wt %) | Type | (μm) |
| Example 21 | Epoxy resin | 35 | Stainless steel flake | 30 |
| | | | Bentonite | |
| Example 22 | Epoxy resin | 35 | Aluminum flake | 30 |
| | | | Bentonite | |
| Example 23 | Epoxy resin | 35 | Mica, Bentonite | 22 |
| Example 24 | Epoxy resin | 85 | Stainless steel flake | 30 |
| | | | Bentonite | |
| Example 25 | Epoxy resin | 68 | Aluminum flake | 30 |
| | | | Bentonite | |
| Example 26 | Epoxy resin | 68 | Mica, Bentonite | 22 |
| Comparative | Epoxy resin | 35 | Stainless steel flake | 30 |
| Example 9 | | | Bentonite | |
| Comparative | Epoxy resin | 35 | Aluminum flake | 30 |
| Example 10 | | | Bentonite | |
| Comparative | Epoxy resin | 35 | Mica, Bentonite | 22 |
| Example 11 | | | | |
| Comparative | Epoxy resin | 85 | Stainless steel flake | Absent |
| Example 12 | | | Bentonite | |

*1Average particle size of inorganic particles

TABLE 5

| | Composition | | | | | | |
|---|---|---|---|---|---|---|---|
| | Graphene | | | | | | |
| | Content based | | | | | | |
| | on total | Average | | Surface | | | Particle |
| | solid weight | thickness | Rb*2 | treatment | O/C | N/C | size ratio |
| | (% by weight) | (nm) | (μm) | agent | ratio | Ratio | Ra/Rb |
| Example 21 | 0.1 | 3.2 | 10 | Dopamine | 0.13 | 0.016 | 3.0 |
| | | | | hydrochloride | | | |
| Example 22 | 0.1 | 3.2 | 10 | Dopamine | 0.13 | 0.016 | 3.0 |
| | | | | hydrochloride | | | |
| Example 23 | 0.1 | 3.2 | 10 | Dopamine | 0.13 | 0.016 | 2.2 |
| | | | | hydrochloride | | | |
| Example 24 | 0.1 | 3.2 | 10 | 1,4- | 0.13 | 0.016 | 3.0 |
| | | | | Phenylenediamine | | | |
| Example 25 | 0.1 | 3.2 | 10 | 1,4- | 0.13 | 0.016 | 3.0 |
| | | | | Phenylenediamine | | | |
| Example 26 | 0.1 | 3.2 | 10 | 1,4- | 0.13 | 0.016 | 2.2 |
| | | | | Phenylenediamine | | | |
| Comparative | Absent | Absent | Absent | Absent | Absent | Absent | Absent |
| Example 9 | | | | | | | |
| Comparative | Absent | Absent | Absent | Absent | Absent | Absent | Absent |
| Example 10 | | | | | | | |
| Comparative | Absent | Absent | Absent | Absent | Absent | Absent | Absent |
| Example 11 | | | | | | | |
| Comparative | Absent | Absent | Absent | Absent | Absent | Absent | Absent |
| Example 12 | | | | | | | |

*2Size of graphene in direction parallel to graphene layer

TABLE 6

| | Evaluation results | | |
|---|---|---|---|
| | Corrosion resistance | | Durability |
| | | Water vapor | Time to reach score 3 |
| | Number of | transmission rate | in salt spray |
| | defects | (g/m² · 24 h) | resistance test (h) |
| Example 21 | 0 | 124 | 720 |
| Example 22 | 0 | 128 | 840 |
| Example 23 | 0 | 120 | 680 |
| Example 24 | 0 | 155 | 680 |
| Example 25 | 0 | 148 | 720 |
| Example 26 | 0 | 158 | 640 |
| Comparative | 0 | 144 | 360 |
| Example 9 | | | |
| Comparative | 0 | 152 | 360 |
| Example 10 | | | |
| Comparative | 0 | 180 | 240 |
| Example 11 | | | |
| Comparative | 4 | 245 | 380 |
| Example 12 | | | |

1. A composition comprising a curable resin and/or a precursor thereof, inorganic particles, and graphene,
wherein the graphene has an average thickness of 0.30 nm or more and 100 nm or less,
wherein a ratio (Ra/Rb) of an average particle size (Ra) of the inorganic particles to a size in a direction parallel to a graphene layer (Rb) of the graphene is 0.5 or more and 6 or less.

2. The composition according to claim 1, wherein the graphene has an average thickness of 0.30 nm or more and 50 nm or less.

3. The composition according to claim 1, wherein the graphene has an average thickness of 0.30 nm or more and 6 nm or less.

4. The composition according to claim 1, wherein the graphene has an element ratio of oxygen to carbon (O/C ratio) measured by X-ray photoelectron spectroscopy of 0.05 or more and 0.40 or less, and an element ratio of nitrogen to carbon (N/C ratio) of 0.005 or more and 0.200 or less.

5. The composition according to claim 1, wherein the graphene is contained in an amount of 0.01% by weight or more and 0.9% by weight or less based on a total solid weight in the composition.

6. The composition according to claim 1, wherein the inorganic particles are contained in an amount of 5% by weight or more and 60% by weight or less based on the total solid weight of the composition.

7. (canceled)

8. The composition according to claim 1, wherein the graphene has a size in a direction parallel to a graphene layer (Rb) of 0.10 μm or more and 100 μm or less.

9. The composition according to claim 1, wherein the composition has a compound having an amino group and/or an aromatic ring on a surface of the graphene.

10. The composition according to claim 1, wherein the inorganic particles contain at least one substance selected from the group consisting of zinc, iron oxide, mica, talc, bentonite, silicon dioxide, titanium oxide, aluminum oxide, barium sulfate, stainless steel, glass, and aluminum.

11. The composition according to claim 10, wherein the inorganic particles contain zinc.

12. A coating material comprising the composition according to claim 1.

13. A coating film formed by applying the coating material according to claim 12.

14. A structure to which the coating material according to claim 12 is applied.
